(19) United States
(12) Patent Application Publication
(10) Pub. No.: US 2026/0105150 A1
(43) Pub. Date: Apr. 16, 2026

(54) Selectively Scanning a File Before Access

(71) Applicant: Dell Products L.P., Round Rock, TX (US)

(72) Inventors: Kaushik Gupta, Pune (IN); Shiv S. Kumar, Pune (IN)

(21) Appl. No.: 18/913,721

(22) Filed: Oct. 11, 2024

(51) Int. Cl. G06F 21/56

(52) U.S. Cl. CPC G06F 21/564; G06F 21/565; G06F 2221/034

(57) ABSTRACT

A system can receive a request to access a file, and determine that a time when the file was most recently modified is more recent than when the file was most recently scanned for viruses with a latest virus definition. The system can determine that a first data store comprises a first indication that indicates that the file has been respectively modified by respective user input received via respective user accounts of at least one user account since the second time at which the file was most recently scanned. The system can determine that a second data store comprises a second indication that indicates that at least one of the at least one user account is classified as a threat user in accordance with a threat criterion. The system can perform an antivirus scan on the file and permit the access to the file where the scan is clear.

### BACKGROUND

A computer system can store files. In some examples, a file can be infected with malicious code that can be referred to as a virus.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can perform a first determining that a first time at which the file was most recently modified is more recent than a second time at which the file was most recently scanned for viruses with a latest virus definition. The system can, based on the first determining, perform a second determining that a first data store comprises a first indication that indicates that the file has been respectively modified by respective user input received via respective user accounts of at least one user account since the second time at which the file was most recently scanned. The system can, based on the second determining, perform a third determining that a second data store comprises a second indication that indicates that at least one of the at least one user account is classified as a threat user in accordance with a threat criterion. The system can, based on the third determining, perform an antivirus scan on the file to produce a result. The system can, based on the result indicating an absence of a virus in the file, permit the access to the file.

An example method can comprise, based on receiving a request to access a file, first determining, by a system comprising at least one processor, that the file has been modified subsequent to a time at which the file was most recently scanned for viruses with a current virus definition. The method can further comprise, based on the first determining, second determining, by the system from first information in a first data store, that the file has been respectively modified by respective user accounts of a group of at least one user account since the time at which the file was most recently scanned. The method can further comprise, based on the second determining, third determining, by the system from second information in a second data store, that a user account of the group of at least one user account is classified as a threat user. The method can further comprise, based on the third determining, scanning, by the system, for viruses in the file to determine an absence of the viruses in the file before permitting the access to the file.

An example non-transitory computer-readable medium can comprise instructions that, in response to execution, cause a system comprising a processor to perform operations. These operations can comprise, based on a first determination that a file that is subject to an access request has been modified subsequent to a time at which the file was most recently scanned for viruses, performing a second determination that a first data store indicates that the file has been respectively modified by respective user accounts of a set of at least one user account since the time at which the file was most recently scanned with a latest virus definition. These operations can further comprise, based on the second determination, making a third determination that a second data store indicates that a user account of the set of at least one user account is classified as a threat user. These operations can further comprise, based on the third determination, performing an antivirus scan with respect to the file to determine that the file is virus free before permitting the access to the file.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate selectively scanning a file before access, in accordance with an embodiment of this disclosure;

FIG. 2 illustrates an example process flow that can facilitate selectively scanning a file before access, in accordance with an embodiment of this disclosure;

FIG. 3 illustrates an example of a threat user database, and that can facilitate selectively scanning a file before access, in accordance with an embodiment of this disclosure;

FIG. 4 illustrates an example of a file changelog, and that can facilitate selectively scanning a file before access, in accordance with an embodiment of this disclosure;

FIG. 5 illustrates another example process flow that can facilitate selectively scanning a file before access, in accordance with an embodiment of this disclosure;

FIG. 6 illustrates another example process flow that can facilitate selectively scanning a file before access, in accordance with an embodiment of this disclosure;

FIG. 7 illustrates another example process flow that can facilitate selectively scanning a file before access, in accordance with an embodiment of this disclosure;

FIG. 8 illustrates another example process flow that can facilitate selectively scanning a file before access, in accordance with an embodiment of this disclosure;

FIG. 9 illustrates another example process flow that can facilitate selectively scanning a file before access, in accordance with an embodiment of this disclosure;

FIG. 10 illustrates another example process flow that can facilitate selectively scanning a file before access, in accordance with an embodiment of this disclosure;

FIG. 11 illustrates another example process flow that can facilitate selectively scanning a file before access, in accordance with an embodiment of this disclosure;

FIG. 12 illustrates another example process flow that can facilitate selectively scanning a file before access, in accordance with an embodiment of this disclosure; and

FIG. 13 illustrates an example block diagram of a computer operable to execute an embodiment of this disclosure.

### DETAILED DESCRIPTION

### Overview

It can be that scan-on-open (performing a virus scan when a computer file is opened) is rarely enabled by users. This can be due to an inherent delay in reading a file, where the delay is introduced by first spending time scanning the file.

It can be that these users instead utilize scheduled antivirus (AV) scan jobs. In such scenarios, even if a directory is scanned, and many files in the directory are detected as infected, an unscanned file that can be infected can be accessed by a user, which can cause a user's computer system to become infected with a virus.

This problem can be addressed via the present techniques. In some examples according to the present techniques, an AV scan policy can be set on a run based on scan results. An AV scan job can compare a number of infected files in a given directory against a configured threshold value. Once a count of infected files for a given directory goes beyond the configured threshold, it can be that all files in that directory (which can be modified more recently than last scanned), can be marked for scan-on-read. This approach can mitigate against a scenario where a file is allowed to be read even after knowing that many files in the same directory have been found to be infected.

Such a directory can be marked as a threat directory (TD). In a threat directory, it can be that any file access request to a file path that resides inside a threat directory and has modified_time>last_scan_time is to be scanned before granting access.

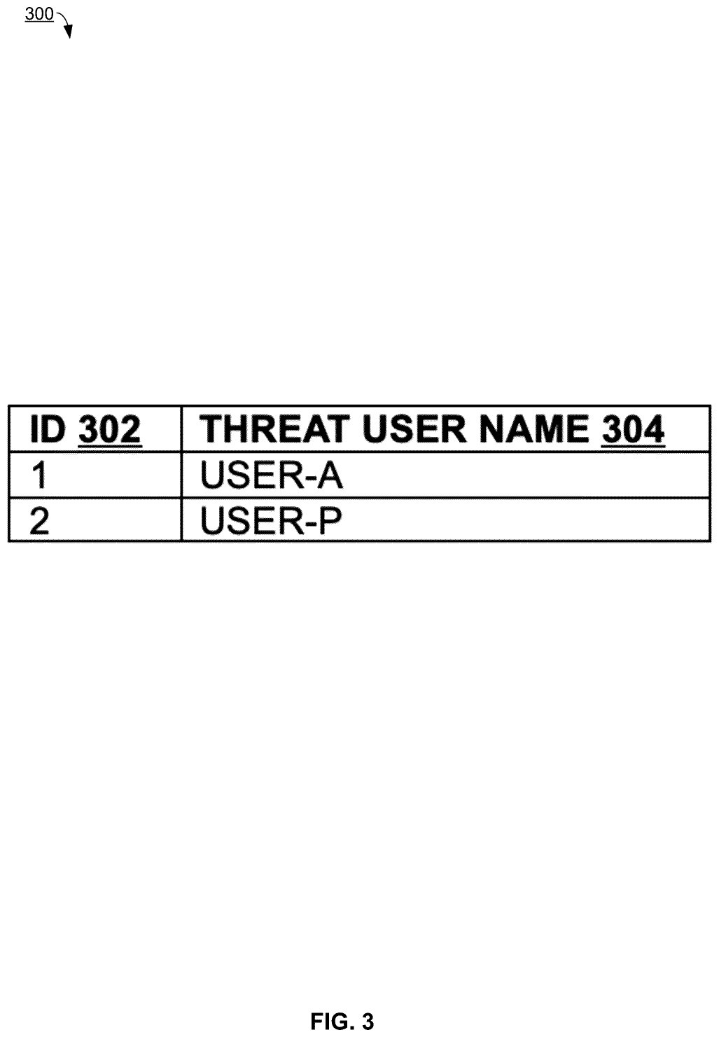

The present techniques can be implemented to facilitate a threat user database (TUD). A TUD can store a list of usernames (where, in different examples, these user names can be added to the TUD according to different criteria). With a TUD, if someone wants to access a file that was modified by a user identified in the TUD, and that file has modified_time>last_scan_time, it can be that access will be granted only after scanning the file.

Where last_scan_time is updated (after a scan), it can be that that file will not be scanned again at least until it is modified. An example TUD is depicted in FIG. 3.

In some examples, a username can be added to a TUD automatically on user creation. There can be a policy where, by default when a user is created, the user-name is added to the TUD for ‘N’ (admin configurable) hours.

In some examples, a username can be added to a TUD manually by an administrator.

In some examples, where an infected file is detected during an AV scan, a changelog (as described below) can be referenced, and every user in the changelog for that infected file can be added to the TUD for ‘M’ (admin configurable) hours.

In some examples, multiple of these approaches for adding a user to a TUD can be used together.

A changelog can comprise a database of key-value pairs that identifies file identifiers (e.g., global file identifiers, or gfids) as a key and the users who wrote to these files (since the last AV scan) as the value.

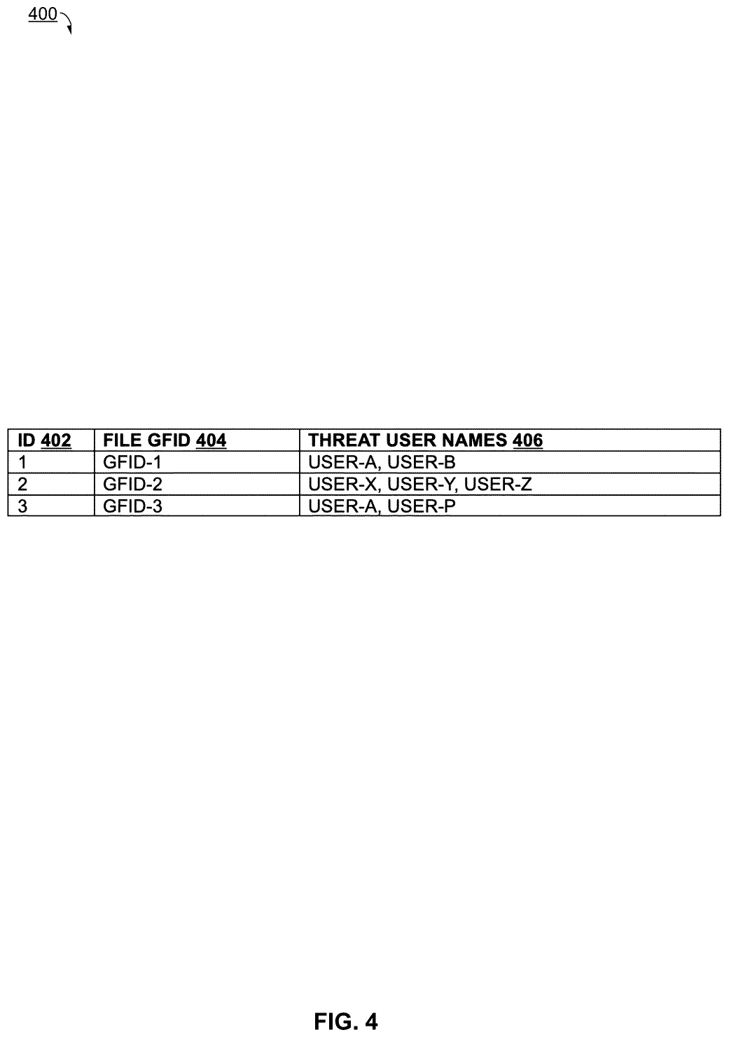

Using this example, when a user writes to a file, the user's name can be either added or appended against the file's gfid. An example changelog is depicted in FIG. 4.

This changelog can be recreated after each scheduled AV job, where immediately after performing an AV scan on a file, no users have written to that file since that last scan. Where not all files are scanned during each AV job, it can be that the changelog can be cleared for each file as it is scanned.

A TUD can aid in avoiding infecting a computer system as follows. In some examples, before allowing access to a file that has modified_time>last_scan_time, it can be first checked whether the requested file's gfid was written to by a user that is also present in the TUD. If Yes, the file can first be scanned, and only after scanning can access to the file be allowed.

In some examples, where a file's last_scan_time>=modified_time, it can be that scanning the file again does not occur (until it is again modified).

### Example Architectures, Etc.

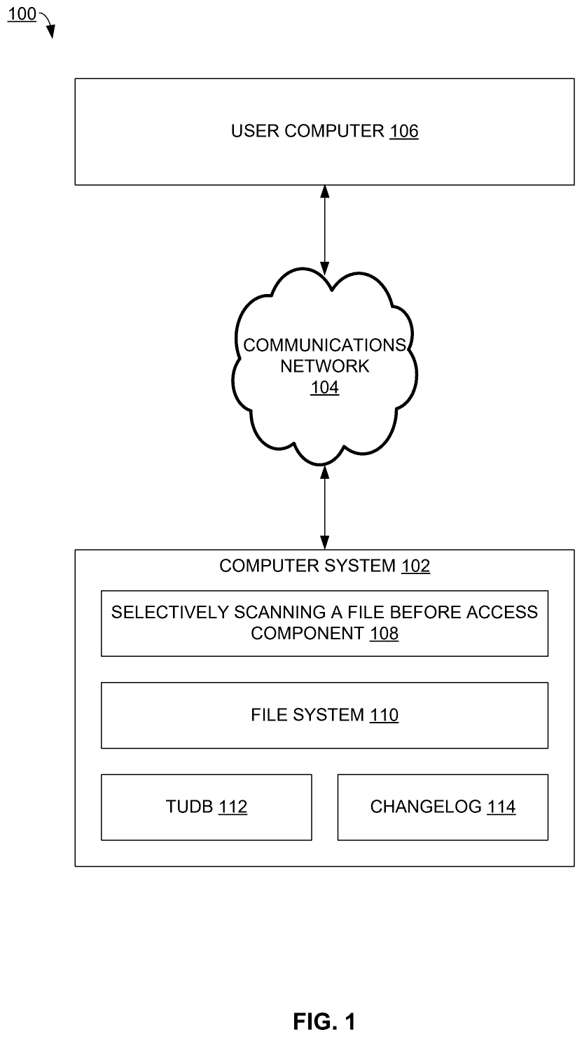

FIG. 1 illustrates an example system architecture 100 that can facilitate selectively scanning a file before access, in accordance with an embodiment of this disclosure.

System architecture 100 comprises computer system 102, communications network 104, and user computer 106. In turn, computer system 102 comprises selectively scanning a file before access component 108, file system 110, threat user database (TUD) 112, and changelog 114.

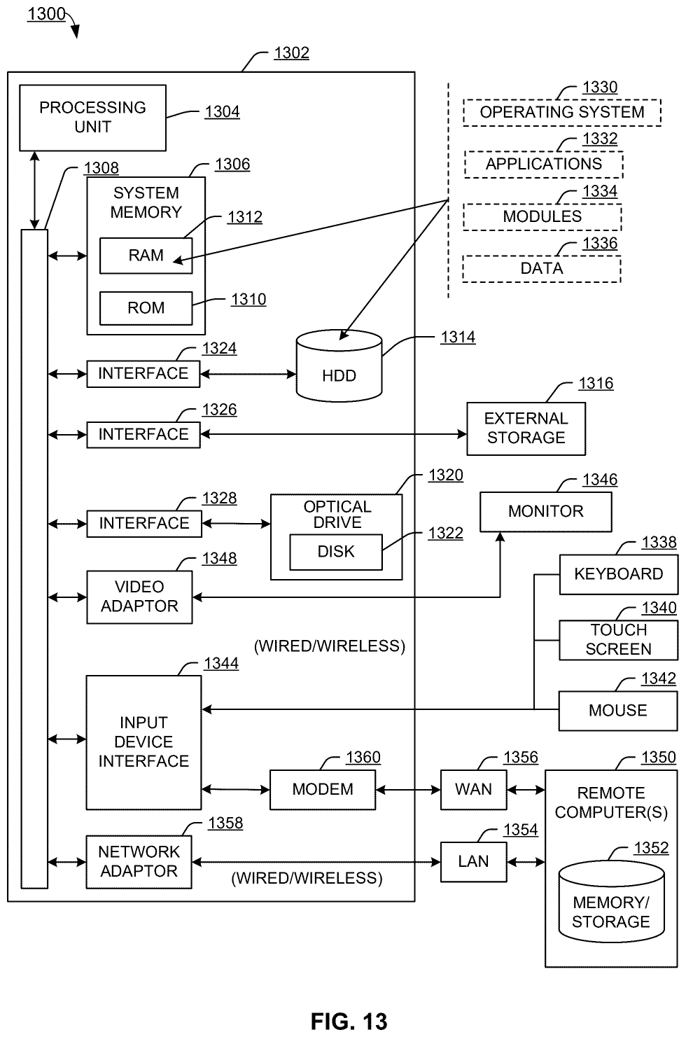

Each of computer system 102 and/or user computer 106 can be implemented with part(s) of computing environment 1300 of FIG. 13. Communications network 104 can comprise a computer communications network, such as the Internet, or an isolated private computer communications network.

User computer 106 can access various files of file system 110, via communications network 104 (e.g., reading from or writing to a file). Files in a file system can become infected with a computer virus, which can generally comprise malicious code that is secretly inserted into a file, such that it will run when the file is read.

To mitigate against a risk of viruses, selectively scanning a file before access component 108 can selectively scan files of file system 110 as requests are made to open these files. A motivation to selectively scan the files on open rather than always scanning the files on open can be to improve a speed at which files are opened.

To selectively scan files of file system 110, selectively scanning a file before access component 108 can utilize information in TUD 112 (as depicted in FIG. 3) and changelog 114 (as depicted in FIG. 4).

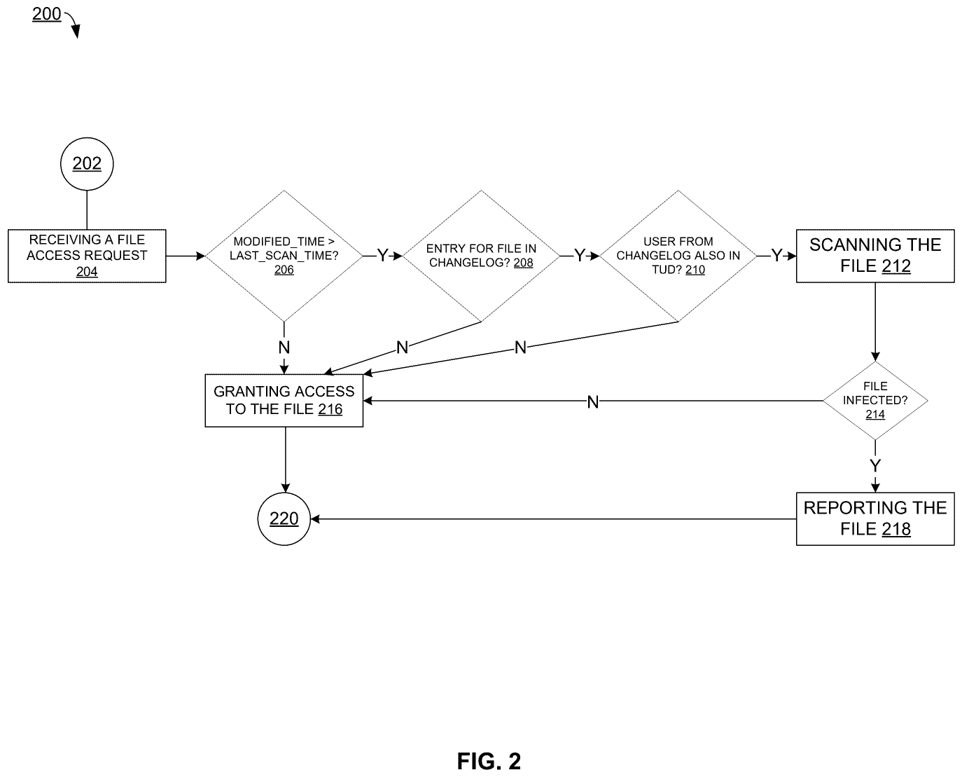

In some examples, selectively scanning a file before access component 108 can implement part(s) of the process flows of FIGS. 2 and/or 5-10 to facilitate selectively scanning a file before access.

It can be appreciated that system architecture 100 is one example system architecture for selectively scanning a file before access, and that there can be other system architectures that facilitate selectively scanning a file before access.

FIG. 2 illustrates an example process flow 200 that can facilitate selectively scanning a file before access, in accordance with an embodiment of this disclosure. In some examples, one or more embodiments of process flow 200 can be implemented by system architecture 100 of FIG. 1, or computing environment 1300 of FIG. 13.

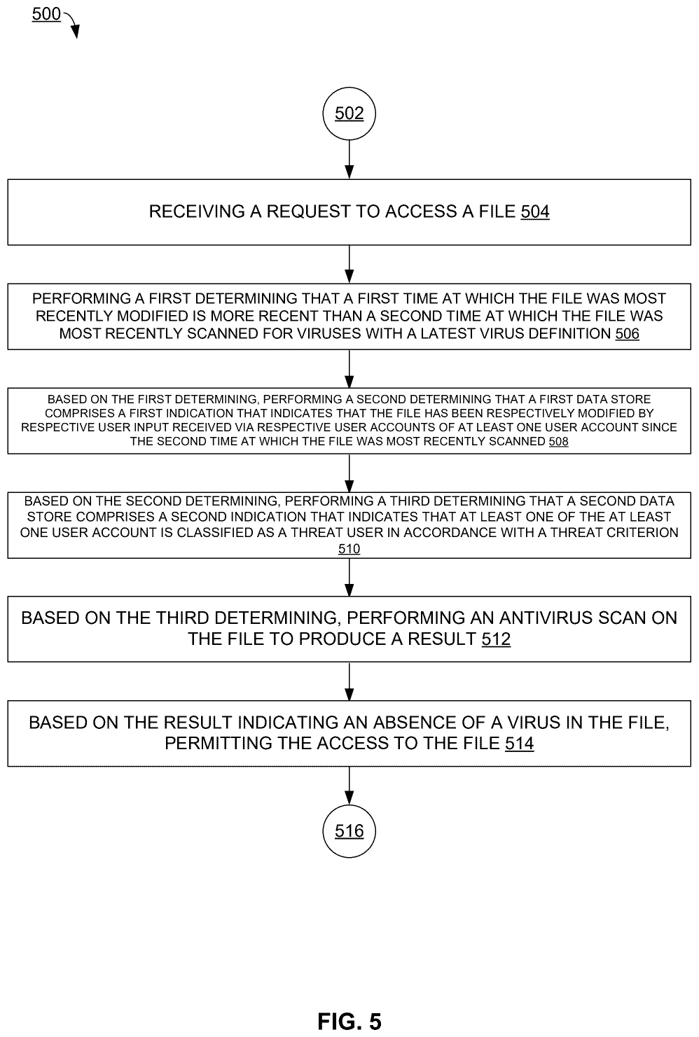

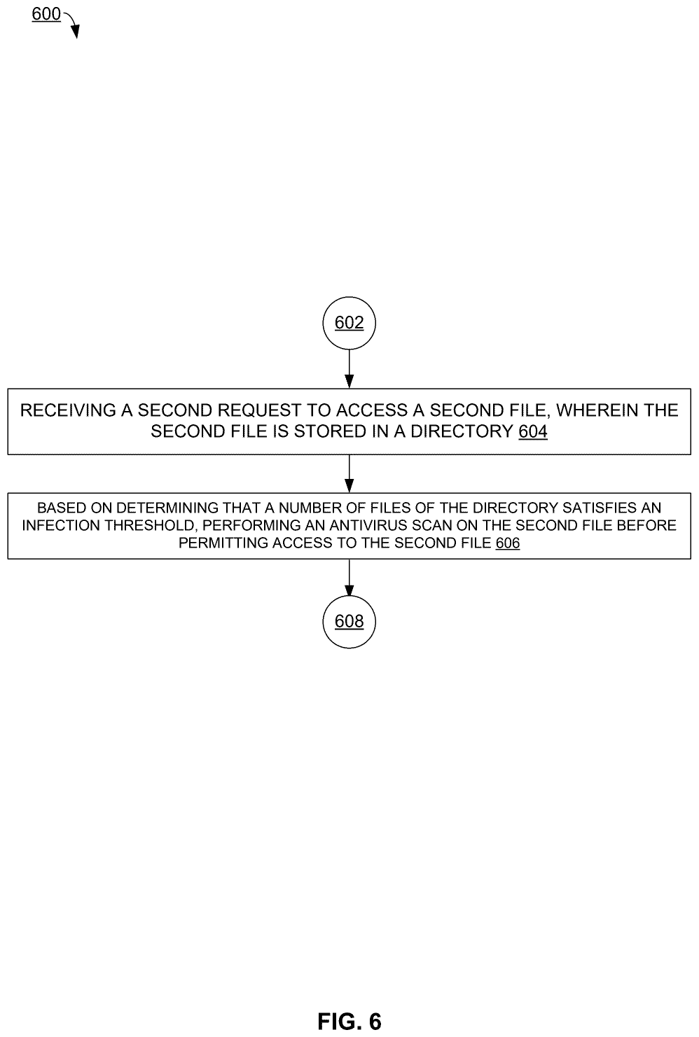

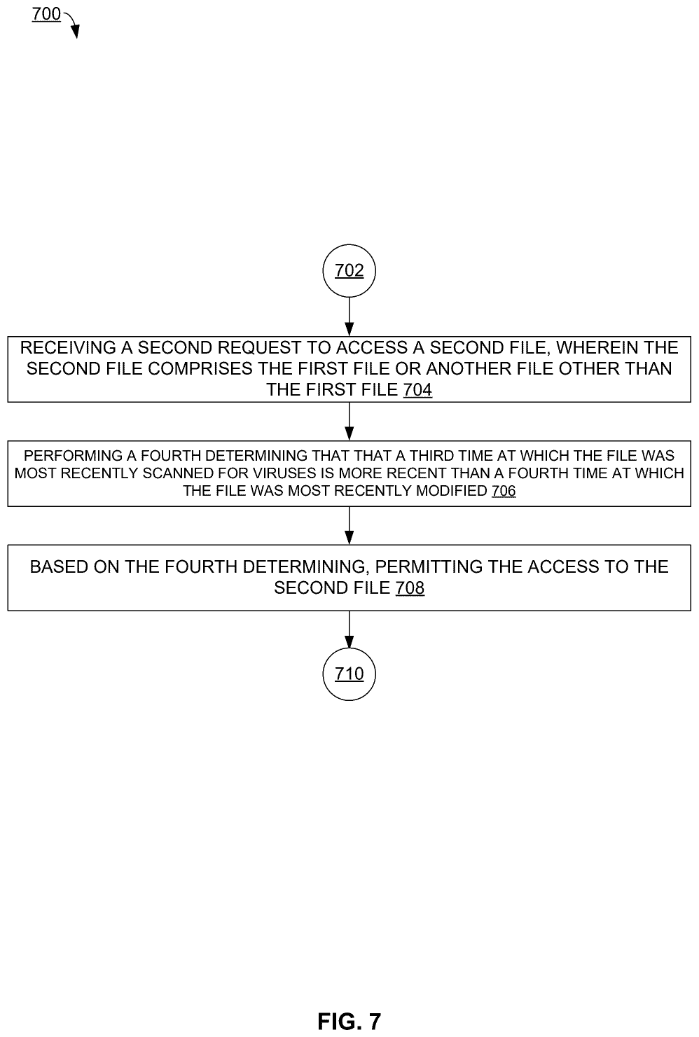

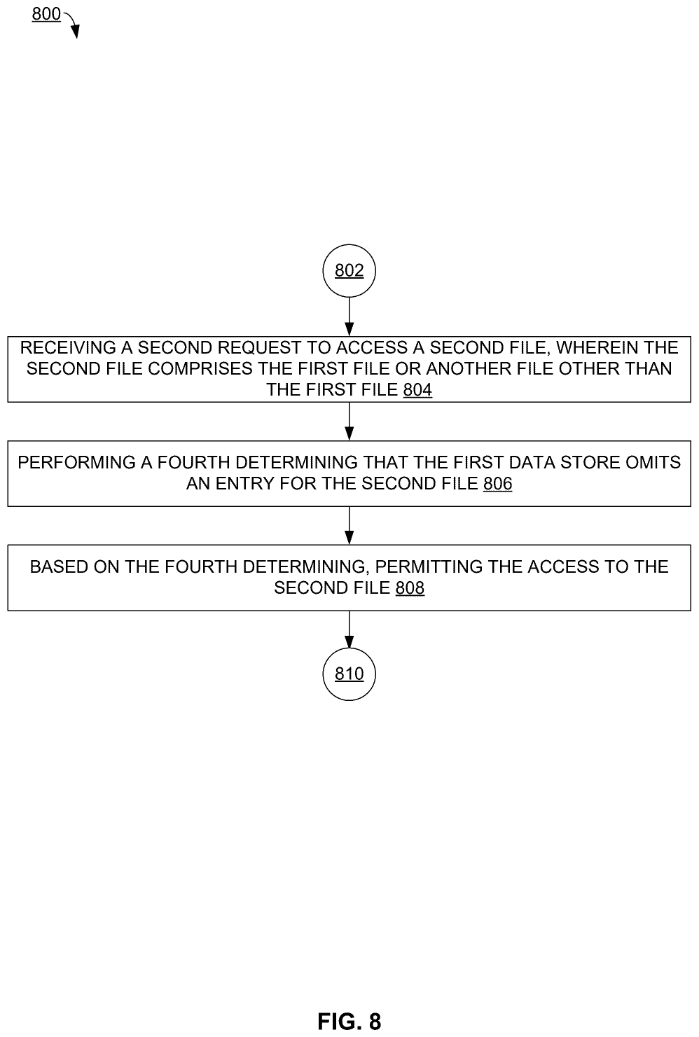

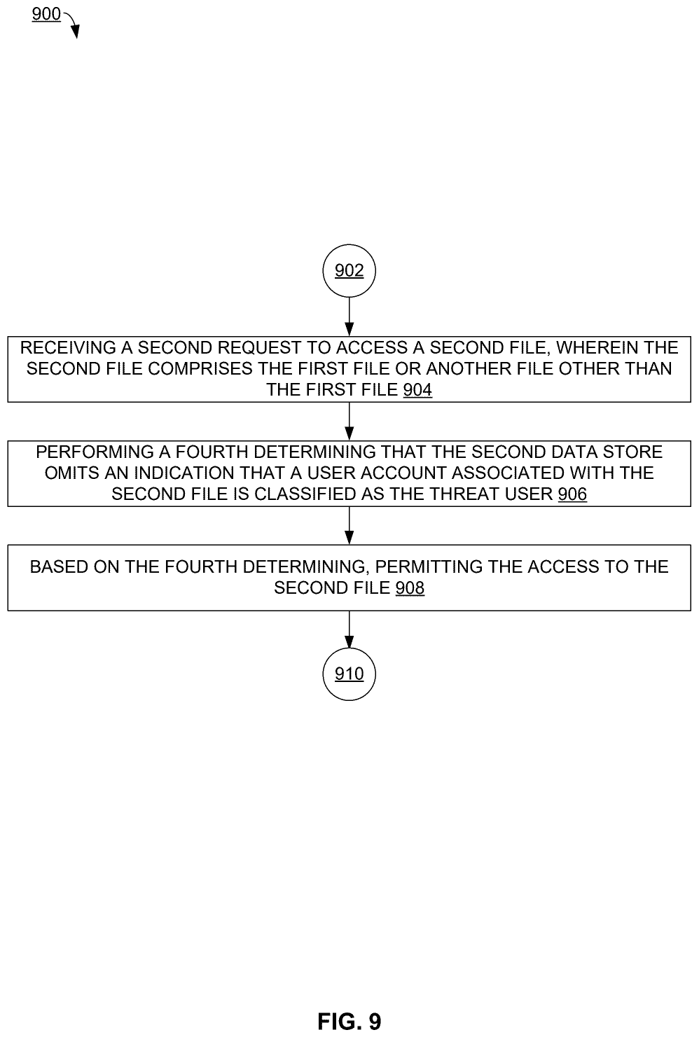

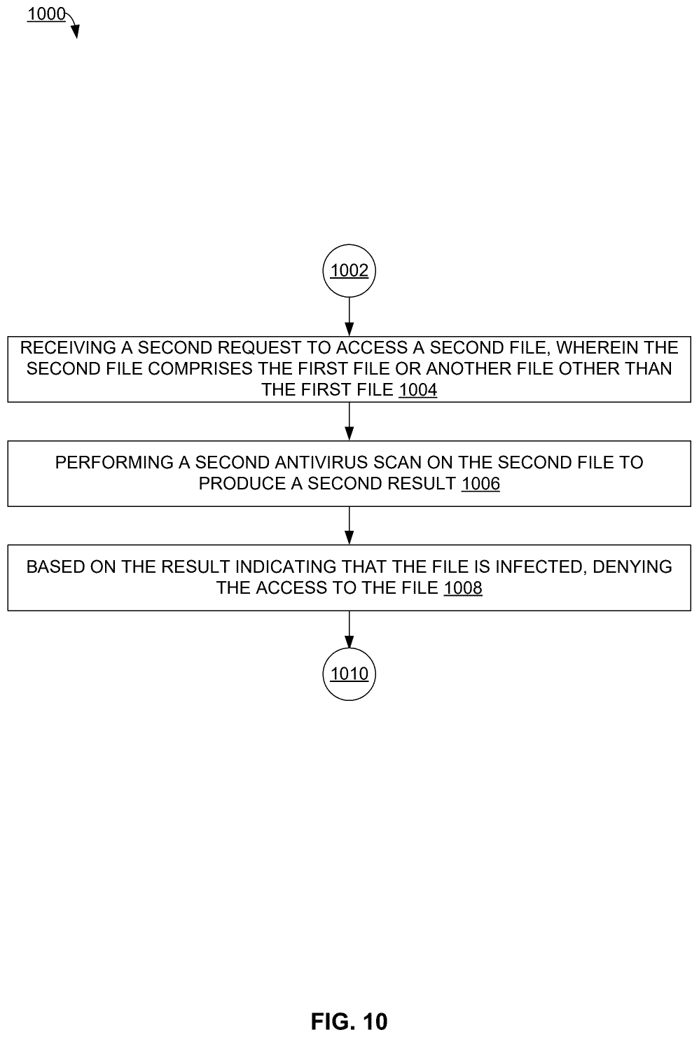

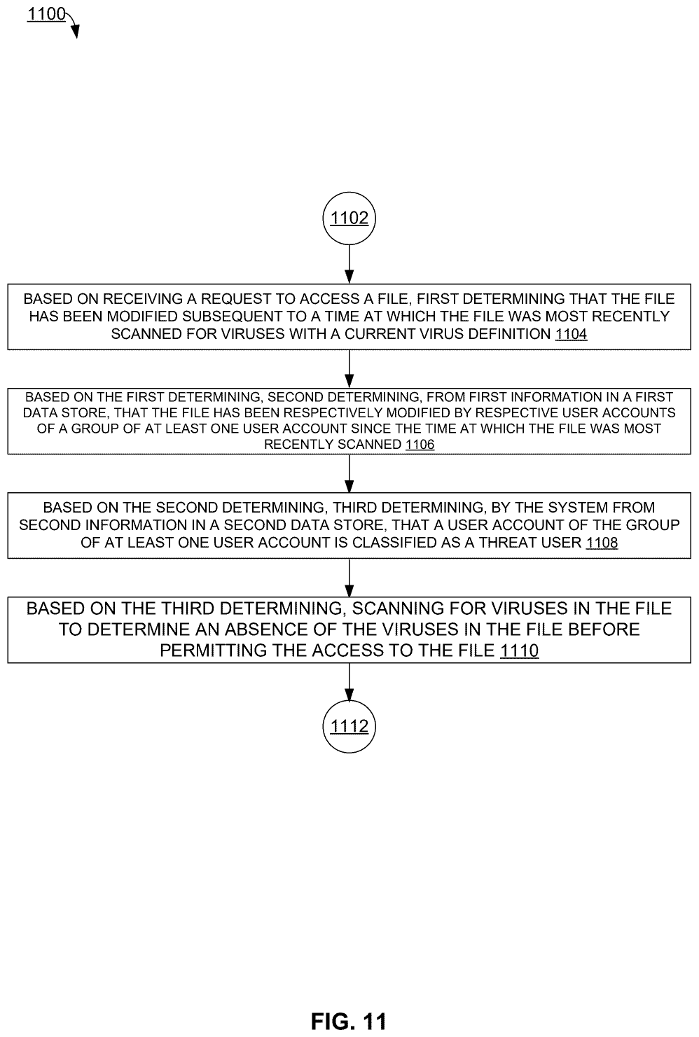

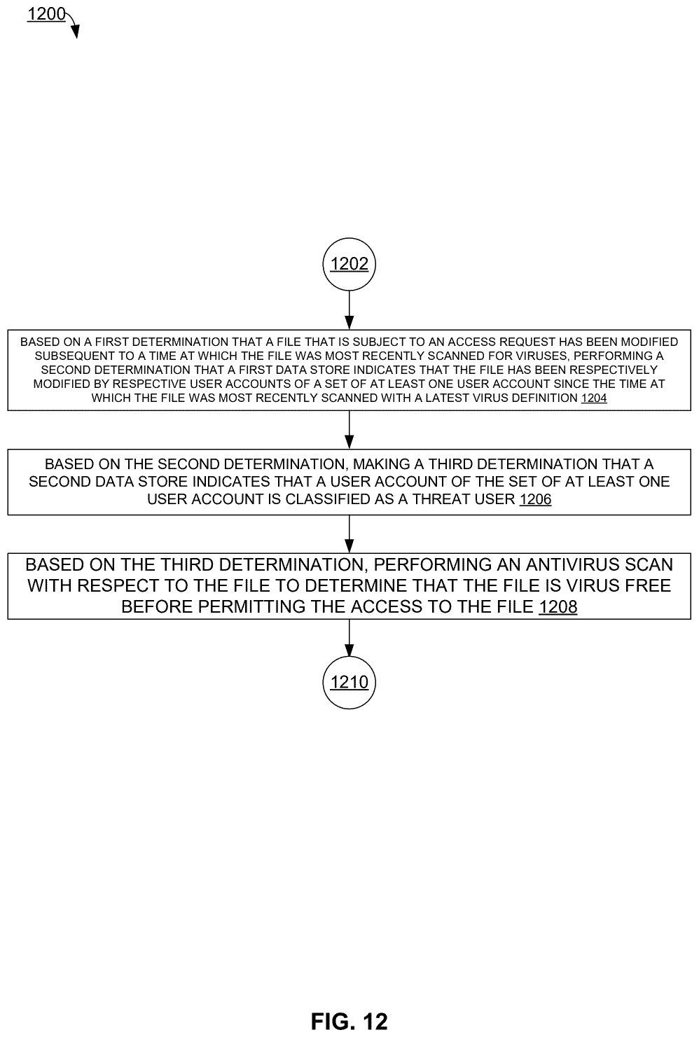

It can be appreciated that the operating procedures of process flow 200 are example operating procedures, and that there can be embodiments that implement more or fewer operating procedures than are depicted, or that implement the depicted operating procedures in a different order than as depicted. In some examples, process flow 200 can be implemented in conjunction with one or more embodiments of process flow 500 of FIG. 5, process flow 600 of FIG. 6, process flow 700 of FIG. 7, process flow 800 of FIG. 8, process flow 900 of FIG. 9, process flow 1000 of FIG. 10, process flow 1100 of FIG. 11, and/or process flow 1200 of FIG. 12.

Process flow 200 begins with 202, and moves to operation 204.

Operation 204 depicts receiving a file access request. Using the example of FIG. 1, this can be a request from user computer 106 to read a file of file system 110.

Operation 206 depicts determining whether a last modified time of the file (modified_time) is more recent than a last scan time of the file (last_scan_time). Both modified_time and last_scan_time can comprise metadata that is maintained for files, and this metadata can be accessed and compared.

In some examples, updating a virus definition file for scanning can cause the last scan time to be reset (e.g., set to a value such as Jan. 1, 1990, such that all files are considered to have been modified since that last scan). This can be to scan files that have not been scanned for the latest virus signatures. In some examples, creating a file can be a form of modifying the file.

Where in operation 206 it is determined that the last modified time of the file is more recent than the last scan time of the file, process flow 200 moves to operation 208. Instead, where in operation 206 it is determined that the last modified time of the file is not more recent than the last scan time of the file, process flow 200 moves to operation 216.

Operation 208 is reached from operation 206 where it is determined that the last modified time of the file is more recent than the last scan time of the file. Operation 208 depicts determining whether there is an entry for the file (e.g., the file's GFID) in the changelog. The changelog can be similar to changelog 114 of FIG. 1.

In some examples, a determination that a file's last modified time is more recent than the file's last scan time can imply an existence of the file in the changelog. However, there can be examples where a changelog is created after some files have been modified (e.g., a computer storage system is used for a period of time, and then the present techniques are implemented on it), and operation 208 can catch these cases.

Where in operation 208 it is determined that there is an entry for the file in the changelog, process flow 200 moves to operation 210. Instead, where in operation 208 it is determined that there is not an entry for the file in the changelog, process flow 200 moves to operation 216.

Operation 210 is reached from operation 208 where it is determined that that there is an entry for the file in the changelog. Operation 210 depicts determining whether there is a user from the changelog (for the file) that is also in the TUD. The TUD can be similar to TUD 112 of FIG. 1. The combination of operations 208 and 210 can be to identify that a particular user has modified the file since it was last scanned, and also that that particular user is classified as a threat user.

Where in operation 210 it is determined that there is a user from the changelog that is also in the TUD, process flow 200 moves to operation 212. Instead, where in operation 210 it is determined that there is not a user from the changelog that is also in the TUD, process flow 200 moves to operation 216.

Operation 212 is reached from operation 210 where it is determined that there is a user from the changelog that is also in the TUD. Operation 212 depicts scanning the file. This can comprise performing an antivirus scan on the file before opening the file for the user.

After operation 212, process flow 200 moves to operation 214.

Operation 214 depicts determining whether the file is infected. This can comprise determining whether a result of the scan in operation 212 indicates that the file is infected with a virus.

Where in operation 214 it is determined that the file is infected, process flow 200 moves to operation 218. Instead, where in operation 214 it is determined that the file is not infected, process flow 200 moves to operation 216.

Operation 216 is reached from operation 206 (where it is determined that the last modified time of the file is not more recent than the last scan time of the file), operation 208 (where it is determined that there is not an entry for the file in the changelog), operation 210 (where it is determined that there is not a user from the changelog that is also in the TUD), or operation 214 (where it is determined that the file is not infected). Operation 216 depicts granting access to the file. This can comprise granting access to the file to the user that requested the access in operation 204, such as allowing the user to read the file.

After operation 216, process flow 200 moves to 220, where process flow 200 ends.

Operation 218 is reached from operation 214 where it is determined that the file is infected. Operation 218 depicts reporting the file. This can comprise raising an alert to an administrator that the file is infected, and can comprise denying the user that requested to access the file (in operation 204) access to the file, because the file has been determined to be infected.

After operation 218, process flow 200 moves to 220, where process flow 200 ends.

FIG. 3 illustrates an example 300 of a threat user database, and that can facilitate selectively scanning a file before access, in accordance with an embodiment of this disclosure. In some examples, part(s) of example 300 can be implemented by part(s) of system architecture 100 of FIG. 1 to facilitate selectively scanning a file before access.

Example 300 comprises identifier (ID) 302 and threat user name 304. ID 302 can identify specific entries within a threat user database, and threat user name 304 can identify specific user accounts that have been classified as threat users. In some examples, where a file has been modified by a threat user (as identified in threat user name 304) since it was last scanned, it can be scanned before it is opened, and in response to a request from a user account to open the file.

FIG. 4 illustrates an example 400 of a file changelog, and that can facilitate selectively scanning a file before access, in accordance with an embodiment of this disclosure. In some examples, part(s) of example 400 can be implemented by part(s) of system architecture 100 of FIG. 1 to facilitate selectively scanning a file before access.

Example 400 comprises ID 402, file GFID 404, and user names 406. ID 302 can identify specific entries within a changelog. File GFID 404 can comprise unique identifiers for files within a file system. In some examples, different ways of identifying files can be implemented, such as by a file path that is updated when the file is moved. User names 406 can identify users that have modified the corresponding file (of file GFID 404) since that file was last modified.

These users who have modified the file since it was last scanned can be compared against threat users (as identified in example 300 of FIG. 3). Where one of the users in user names 406 is a threat user, the file can be scanned before opening it for a user.

This approach with a TUD and a changelog can account for users that are classified as threat users changing dynamically (e.g., where each new user is classified as a threat user for 1 day after account creation). The TUD can be updated as users gain or lose a threat user classification. The changelog can track all users that have modified particular files since those files were last scanned. Then, upon a file open request, the users in the changelog can be compared against the users in the TUD that are currently classified as threat users to determine whether a threat user has modified the file since it was last scanned.

### Example Procss Flows

FIG. 5 illustrates another example process flow that can facilitate selectively scanning a file before access, in accordance with an embodiment of this disclosure. In some examples, one or more embodiments of process flow 500 can be implemented by system architecture 100 of FIG. 1, or computing environment 1300 of FIG. 13.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of process flow 200 of FIG. 2, process flow 600 of FIG. 6, process flow 700 of FIG. 7, process flow 800 of FIG. 8, process flow 900 of FIG. 9, process flow 1000 of FIG. 10, process flow 1100 of FIG. 11, and/or process flow 1200 of FIG. 12.

Process flow 500 begins with 502, and moves to operation 504.

Operation 504 depicts receiving a request to access a file. This can be implemented in a similar manner as operation 204 of FIG. 2.

After operation 504, process flow 500 moves to operation 506.

Operation 506 depicts performing a first determining that a first time at which the file was most recently modified is more recent than a second time at which the file was most recently scanned for viruses with a latest virus definition. This can be implemented in a similar manner as operation 206 of FIG. 2.

After operation 506, process flow 500 moves to operation 508.

Operation 508 depicts, based on the first determining, performing a second determining that a first data store comprises a first indication that indicates that the file has been respectively modified by respective user input received via respective user accounts of at least one user account since the second time at which the file was most recently scanned. This can be implemented in a similar manner as operation 208 of FIG. 2.

In some examples, the first data store comprises entries, and respective entries of the entries comprise respective file identifiers of respective files and respective groups of at least one user account that has modified the respective files since respective second times at which the respective files were most recently scanned. That is, the first data store can be a changelog as depicted in FIG. 3.

In some examples, operation 508 comprises clearing the first data store after scanning the files. In some examples, operation 508 comprises after performing the antivirus scan on the file, and based on the result indicating an absence of the virus in the file, removing a first entry of the first data store that corresponds to the file. That is, an entire changelog can be cleared after a system-wide scan, and/or one entry for one file can be cleared after scanning that file.

After operation 508, process flow 500 moves to operation 510.

Operation 510 depicts, based on the second determining, performing a third determining that a second data store comprises a second indication that indicates that at least one of the at least one user account is classified as a threat user in accordance with a threat criterion. This can be implemented in a similar manner as operation 210 of FIG. 2.

After operation 510, process flow 500 moves to operation 512.

Operation 512 depicts, based on the third determining, performing an antivirus scan on the file to produce a result. This can be implemented in a similar manner as operation 212 of FIG. 2.

After operation 512, process flow 500 moves to operation 514.

Operation 514 depicts, based on the result indicating an absence of a virus in the file, permitting the access to the file. This can be implemented in a similar manner as operations 214-216 of FIG. 2.

After operation 514, process flow 500 moves to 516, where process flow 500 ends.

FIG. 6 illustrates another example process flow that can facilitate selectively scanning a file before access, in accordance with an embodiment of this disclosure. In some examples, one or more embodiments of process flow 600 can be implemented by system architecture 100 of FIG. 1, or computing environment 1300 of FIG. 13.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of process flow 200 of FIG. 2, process flow 500 of FIG. 5, process flow 700 of FIG. 7, process flow 800 of FIG. 8, process flow 900 of FIG. 9, process flow 1000 of FIG. 10, process flow 1100 of FIG. 11, and/or process flow 1200 of FIG. 12.

Process flow 600 begins with 602, and moves to operation 604.

In some examples, process flow 600 is implemented in conjunction with process flow 500 of FIG. 5, the request is a first request, and the file is a first file.

Operation 604 depicts receiving a second request to access a second file, wherein the second file is stored in a directory. Using the example of FIG. 1, this can be a file of file system 110.

After operation 604, process flow 600 moves to operation 606.

Operation 606 depicts, based on determining that a number of files of the directory satisfies an infection threshold, performing an antivirus scan on the second file before permitting access to the second file. That is, where a particular directory has enough infected files (e.g., compared to a threshold), it can be that all files in that directory are to be scanned at a time of being opened.

After operation 606, process flow 600 moves to 608, where process flow 600 ends.

FIG. 7 illustrates another example process flow that can facilitate selectively scanning a file before access, in accordance with an embodiment of this disclosure. In some examples, one or more embodiments of process flow 700 can be implemented by system architecture 100 of FIG. 1, or computing environment 1300 of FIG. 13.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of process flow 200 of FIG. 2, process flow 500 of FIG. 5, process flow 600 of FIG. 6, process flow 800 of FIG. 8, process flow 900 of FIG. 9, process flow 1000 of FIG. 10, process flow 1100 of FIG. 11, and/or process flow 1200 of FIG. 12.

Process flow 700 begins with 702, and moves to operation 704.

In some examples, process flow 700 is implemented in conjunction with process flow 500 of FIG. 5, the request is a first request, and the file is a first file. Using the example of FIG. 1, this can be a file of file system 110.

Operation 704 depicts receiving a second request to access a second file, wherein the second file comprises the first file or another file other than the first file.

After operation 704, process flow 700 moves to operation 706.

Operation 706 depicts performing a fourth determining that that a third time at which the file was most recently scanned for viruses is more recent than a fourth time at which the file was most recently modified. This can be determining that the modified_time<last_scan_time in operation 206 of FIG. 2.

After operation 706, process flow 700 moves to operation 708.

Operation 708 depicts, based on the fourth determining, permitting the access to the second file. This can be implemented in a similar manner as operation 216 of FIG. 2.

After operation 708, process flow 700 moves to 710, where process flow 700 ends.

FIG. 8 illustrates another example process flow that can facilitate selectively scanning a file before access, in accordance with an embodiment of this disclosure. In some examples, one or more embodiments of process flow 800 can be implemented by system architecture 100 of FIG. 1, or computing environment 1300 of FIG. 13.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 200 of FIG. 2, process flow 500 of FIG. 5, process flow 600 of FIG. 6, process flow 700 of FIG. 7, process flow 900 of FIG. 9, process flow 1000 of FIG. 10, process flow 1100 of FIG. 11, and/or process flow 1200 of FIG. 12.

Process flow 800 begins with 802, and moves to operation 804.

In some examples, process flow 800 is implemented in conjunction with process flow 500 of FIG. 5, the request is a first request, and the file is a first file.

Operation 804 depicts receiving a second request to access a second file, wherein the second file comprises the first file or another file other than the first file. This can be implemented in a similar manner as operation 704 of FIG. 7.

After operation 804, process flow 800 moves to operation 806.

Operation 806 depicts performing a fourth determining that the first data store omits an entry for the second file. This can be determining that there is not an entry for the file in the changelog in operation 208.

After operation 806, process flow 800 moves to operation 808.

Operation 808 depicts, based on the fourth determining, permitting the access to the second file. This can be implemented in a similar manner as operation 216 of FIG. 2.

After operation 808, process flow 800 moves to 810, where process flow 800 ends.

FIG. 9 illustrates another example process flow that can facilitate selectively scanning a file before access, in accordance with an embodiment of this disclosure. In some examples, one or more embodiments of process flow 900 can be implemented by system architecture 100 of FIG. 1, or computing environment 1300 of FIG. 13.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 200 of FIG. 2, process flow 500 of FIG. 5, process flow 600 of FIG. 6, process flow 700 of FIG. 7, process flow 800 of FIG. 8, process flow 1000 of FIG. 10, process flow 1100 of FIG. 11, and/or process flow 1200 of FIG. 12.

Process flow 900 begins with 902, and moves to operation 904.

In some examples, process flow 900 is implemented in conjunction with process flow 500 of FIG. 5, the request is a first request, and the file is a first file.

Operation 904 depicts receiving a second request to access a second file, wherein the second file comprises the first file or another file other than the first file. This can be implemented in a similar manner as operation 704 of FIG. 7.

After operation 904, process flow 900 moves to operation 906.

Operation 906 depicts performing a fourth determining that the second data store omits an indication that a user account associated with the second file is classified as the threat user. This can comprise determining that the user is not identified in the threat user database in operation 210 of FIG. 2.

After operation 906, process flow 900 moves to operation 908.

Operation 908 depicts, based on the fourth determining, permitting the access to the second file. This can be implemented in a similar manner as operation 216 of FIG. 2.

After operation 908, process flow 900 moves to 910, where process flow 900 ends.

FIG. 10 illustrates another example process flow that can facilitate selectively scanning a file before access, in accordance with an embodiment of this disclosure. In some examples, one or more embodiments of process flow 1000 can be implemented by system architecture 100 of FIG. 1, or computing environment 1300 of FIG. 13.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of process flow 200 of FIG. 2, process flow 500 of FIG. 5, process flow 600 of FIG. 6, process flow 700 of FIG. 7, process flow 800 of FIG. 8, process flow 900 of FIG. 9, process flow 1100 of FIG. 11, and/or process flow 1200 of FIG. 12.

Process flow 1000 begins with 1002, and moves to operation 1004.

In some examples, process flow 1000 is implemented in conjunction with process flow 500 of FIG. 5, the request is a first request, the file is a first file, the antivirus scan is a first antivirus scan, and the result is a first result.

Operation 1004 depicts receiving a second request to access a second file, wherein the second file comprises the first file or another file other than the first file.

After operation 1004, process flow 1000 moves to operation 1006.

Operation 1006 depicts performing a second antivirus scan on the second file to produce a second result. This can be implemented in a similar manner as operation 214 of FIG. 2.

After operation 1006, process flow 1000 moves to operation 1008.

Operation 1008 depicts, based on the result indicating that the file is infected, denying the access to the file. This can be implemented in a similar manner as operation 218 of FIG. 2.

After operation 1008, process flow 1000 moves to 1010, where process flow 1000 ends.

FIG. 11 illustrates another example process flow that can facilitate selectively scanning a file before access, in accordance with an embodiment of this disclosure. In some examples, one or more embodiments of process flow 1100 can be implemented by system architecture 100 of FIG. 1, or computing environment 1300 of FIG. 13.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of process flow 200 of FIG. 2, process flow 500 of FIG. 5, process flow 600 of FIG. 6, process flow 700 of FIG. 7, process flow 800 of FIG. 8, process flow 900 of FIG. 9, process flow 1000 of FIG. 10, and/or process flow 1200 of FIG. 12.

Process flow 1100 begins with 1102, and moves to operation 1104.

Operation 1104 depicts, based on receiving a request to access a file, first determining that the file has been modified subsequent to a time at which the file was most recently scanned for viruses with a current virus definition. In some examples, operation 1104 can be implemented in a similar manner as operations 504-506 of FIG. 5.

After operation 1104, process flow 1100 moves to operation 1106.

Operation 1106 depicts, based on the first determining, second determining, from first information in a first data store, that the file has been respectively modified by respective user accounts of a group of at least one user account since the time at which the file was most recently scanned. In some examples, operation 1106 can be implemented in a similar manner as operation 508 of FIG. 5.

After operation 1106, process flow 1100 moves to operation 1108.

Operation 1108 depicts, based on the second determining, third determining, by the system from second information in a second data store, that a user account of the group of at least one user account is classified as a threat user. In some examples, operation 1108 can be implemented in a similar manner as operation 510 of FIG. 5.

In some examples, the second data store comprises respective identifications of respective user accounts that are independent from respective indications of respective files. That is, the second data store can comprise a threat user database, as depicted in FIG. 4.

In some examples, operation 1108 comprises adding an indication of the user account to the second data store as part of creating the user account. In some examples, the adding is effective for a defined amount of time. In some examples, the defined amount of time is determined based on user input data associated with an administrator account of the system. That is, a newly-created user account can be added to a threat user database for a defined amount of time, and this amount of time can be specified by an administrator.

After operation 1108, process flow 1100 moves to operation 1110.

Operation 1110 depicts, based on the third determining, scanning for viruses in the file to determine an absence of the viruses in the file before permitting the access to the file. In some examples, operation 1110 can be implemented in a similar manner as operations 512-514 of FIG. 5.

In some examples, the request is a first request, and operation 1010 comprises, after the scanning, receiving a second request to access the file, and permitting a second access to the file based on determining that the file has not been modified subsequent to the scanning. That is, where there is another access of the file after it was scanned (in operation 1110), and that file has not been modified since that scan, an additional scan can be skipped as part of providing access to the file.

After operation 1110, process flow 1100 moves to 1112, where process flow 1100 ends.

FIG. 12 illustrates another example process flow that can facilitate selectively scanning a file before access, in accordance with an embodiment of this disclosure. In some examples, one or more embodiments of process flow 1200 can be implemented by system architecture 100 of FIG. 1, or computing environment 1300 of FIG. 13.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of process flow 200 of FIG. 2, process flow 500 of FIG. 5, process flow 600 of FIG. 6, process flow 700 of FIG. 7, process flow 800 of FIG. 8, process flow 900 of FIG. 9, process flow 1000 of FIG. 10, and/or process flow 1100 of FIG. 11.

Process flow 1200 begins with 1202, and moves to operation 1204.

Operation 1204 depicts, based on a first determination that a file that is subject to an access request has been modified subsequent to a time at which the file was most recently scanned for viruses, performing a second determination that a first data store indicates that the file has been respectively modified by respective user accounts of a set of at least one user account since the time at which the file was most recently scanned with a latest virus definition. In some examples, operation 1204 can be implemented in a similar manner as operations 504-508 of FIG. 5.

In some examples, the first data store stores an indication of a file identifier of the file, wherein the file identifier of the file uniquely identifies the file within a file storage system, wherein the file identifier is separate from a name of the file, and wherein the file identifier is separate from a file system path of the file. That is, a changelog can identify files by their GFID.

After operation 1204, process flow 1200 moves to operation 1206.

Operation 1206 depicts, based on the second determination, making a third determination that a second data store indicates that a user account of the set of at least one user account is classified as a threat user. In some examples, operation 1206 can be implemented in a similar manner as operation 510 of FIG. 5.

In some examples, operation 1206 comprises adding an indication of a user account to the second data store based on user input data associated with an administrator account of the system. In some examples, the adding is effective for a defined amount of time. That is, an administrator can manually add a user account to a threat user database, and this can be in effect for a defined amount of time.

In some examples, operation 1206 comprises adding an indication a second user account to the second data store based on a fourth determination that a second file is infected, and that there is an association between the second file and a first user account stored in the first data store. That is, where an infected file is discovered during a scan, the changelog can be consulted, and each user identified in the changelog as having modified the file can be added to the threat user database.

After operation 1206, process flow 1200 moves to operation 1208.

Operation 1208 depicts, based on the third determination, performing an antivirus scan with respect to the file to determine that the file is virus free before permitting the access to the file. In some examples, operation 1208 can be implemented in a similar manner as operation 514 of FIG. 5.

After operation 1208, process flow 1200 moves to 1210, where process flow 1200 ends.

### Example Operating Environment

In order to provide additional context for various embodiments described herein, FIG. 13 and the following discussion are intended to provide a brief, general description of a suitable computing environment 1300 in which the various embodiments of the embodiment described herein can be implemented.

For example, parts of computing environment 1300 can be used to implement one or more embodiments of computer system 102 and/or user computer 106 of FIG. 1.

In some examples, computing environment 1300 can implement one or more embodiments of the process flows of FIGS. 2 and/or 5-10 to facilitate selectively scanning a file before access.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a nonvolatile storage such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and an optical disk drive 1320 (e.g., which can read or write from a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid state drive (SSD) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are examples, and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1316 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
receiving a request to access a file;
performing a first determining that a first time at which the file was most recently modified is more recent than a second time at which the file was most recently scanned for viruses with a latest virus definition;
based on the first determining, performing a second determining that a first data store comprises a first indication that indicates that the file has been respectively modified by respective user input received via respective user accounts of at least one user account since the second time at which the file was most recently scanned;
based on the second determining, performing a third determining that a second data store comprises a second indication that indicates that at least one of the at least one user account is classified as a threat user in accordance with a threat criterion; and
based on the third determining, performing an antivirus scan on the file to produce a result; and
based on the result indicating an absence of a virus in the file, permitting the access to the file.

2. The system of claim 1, wherein the request is a first request, wherein the file is a first file, and wherein the operations further comprise:
receiving a second request to access a second file, wherein the second file is stored in a directory; and
based on determining that a number of files of the directory satisfies an infection threshold, performing an antivirus scan on the second file before permitting access to the second file.

3. The system of claim 1, wherein the request is a first request, wherein the file is a first file, and wherein the operations further comprise:
receiving a second request to access a second file, wherein the second file comprises the first file or another file other than the first file;
performing a fourth determining that that a third time at which the file was most recently scanned for viruses is more recent than a fourth time at which the file was most recently modified; and
based on the fourth determining, permitting the access to the second file.

4. The system of claim 1, wherein the request is a first request, wherein the file is a first file, and wherein the operations further comprise:
receiving a second request to access a second file, wherein the second file comprises the first file or another file other than the first file;
performing a fourth determining that the first data store omits an entry for the second file; and
based on the fourth determining, permitting the access to the second file.

5. The system of claim 1, wherein the request is a first request, wherein the file is a first file, and wherein the operations further comprise:
receiving a second request to access a second file, wherein the second file comprises the first file or another file other than the first file;
performing a fourth determining that the second data store omits an indication that a user account associated with the second file is classified as the threat user; and
based on the fourth determining, permitting the access to the second file.

6. The system of claim 1, wherein the request is a first request, wherein the file is a first file, wherein the antivirus scan is a first antivirus scan, wherein the result is a first result, and wherein the operations further comprise:
receiving a second request to access a second file, wherein the second file comprises the first file or another file other than the first file;
performing a second antivirus scan on the second file to produce a second result; and
based on the result indicating that the file is infected, denying the access to the file.

7. The system of claim 1, wherein the first data store comprises entries, wherein respective entries of the entries comprise respective file identifiers of respective files and respective groups of at least one user account that has modified the respective files since respective second times at which the respective files were most recently scanned.

8. The system of claim 7, wherein the operations further comprise:
clearing the first data store after scanning the files.

9. The system of claim 7, wherein the operations further comprise:
after performing the antivirus scan on the file, and based on the result indicating an absence of the virus in the file, removing a first entry of the first data store that corresponds to the file.

10. A method, comprising:
based on receiving a request to access a file, first determining, by a system comprising at least one processor, that the file has been modified subsequent to a time at which the file was most recently scanned for viruses with a current virus definition;
based on the first determining, second determining, by the system from first information in a first data store, that the file has been respectively modified by respective user accounts of a group of at least one user account since the time at which the file was most recently scanned;
based on the second determining, third determining, by the system from second information in a second data store, that a user account of the group of at least one user account is classified as a threat user; and
based on the third determining, scanning, by the system, for viruses in the file to determine an absence of the viruses in the file before permitting the access to the file.

11. The method of claim 10, wherein the second data store comprises respective identifications of respective user accounts that are independent from respective indications of respective files.

12. The method of claim 10, wherein the request is a first request, and further comprising:
after the scanning, receiving, by the system, a second request to access the file; and
permitting, by the system, a second access to the file based on determining that the file has not been modified subsequent to the scanning.

13. The method of claim 10, wherein the operations further comprise:
adding an indication of the user account to the second data store as part of creating the user account.

14. The method of claim 13, wherein the adding is effective for a defined amount of time.

15. The method of claim 14, wherein the defined amount of time is determined based on user input data associated with an administrator account of the system.

16. A non-transitory computer-readable medium comprising instructions that, in response to execution, cause a system comprising at least one processor to perform operations, comprising:
based on a first determination that a file that is subject to an access request has been modified subsequent to a time at which the file was most recently scanned for viruses, performing a second determination that a first data store indicates that the file has been respectively modified by respective user accounts of a set of at least one user account since the time at which the file was most recently scanned with a latest virus definition;
based on the second determination, making a third determination that a second data store indicates that a user account of the set of at least one user account is classified as a threat user; and
based on the third determination, performing an antivirus scan with respect to the file to determine that the file is virus free before permitting the access to the file.

17. The non-transitory computer-readable medium of claim 16, wherein the operations further comprise:
adding an indication of a user account to the second data store based on user input data associated with an administrator account of the system.

18. The non-transitory computer-readable medium of claim 17, wherein the adding is effective for a defined amount of time.

19. The non-transitory computer-readable medium of claim 16, wherein the operations further comprise:
adding an indication a second user account to the second data store based on a fourth determination that a second file is infected, and that there is an association between the second file and a first user account stored in the first data store.

20. The non-transitory computer-readable medium of claim 16, wherein the first data store stores an indication of a file identifier of the file, wherein the file identifier of the file uniquely identifies the file within a file storage system, wherein the file identifier is separate from a name of the file, and wherein the file identifier is separate from a file system path of the file.
